(19) United States
(12) Patent Application Publication
(10) Pub. No.: US 2018/0032376 A1
(43) Pub. Date: Feb. 1, 2018

(54) APPARATUS AND METHOD FOR GROUP-BASED SCHEDULING IN MULTI-CORE PROCESSOR SYSTEM

(71) Applicant: Samsung Electronics Co., Ltd., Suwon-si (KR)

(72) Inventors: Raju Siddappa UDAVA, Bangalore (IN); Balaji SOMU KANDASWAMY, Bangalore (IN); Prasanth SUBRAMANI, Bangalore (IN); Tushar VRIND, Bangalore (IN); Venkata Raju INDUKURI, Bangalore (IN); Diwakar SHARMA, Bangalore (IN)

(73) Assignee: Samsung Electronics Co .. Ltd., Suwon-si (KR)

(21) Appl. No.: 15/660,246

(22) Filed: Jul. 26, 2017

(30) Foreign Application Priority Data
Jul. 27, 2016 (IN) 201641025728

(51) Int. Cl. G06F 9/50; G06F 9/48

(52) U.S. Cl. CPC G06F 9/5061; G06F 9/5038; G06F 9/4881

(57) ABSTRACT

A method for group-based scheduling in a multi-core processor apparatus comprises computing a cost of at least two tasks accessing a same resource based on a plurality of parameters; determining, by the multi-core processor apparatus, inter-dependent tasks from among a plurality of tasks based on a plurality of parameters by comparing the computed cost of the at least two tasks with a task inter-dependent threshold; generating, by the multi-core processor apparatus, at least one task group including the inter-dependent tasks; and scheduling, by multi-core processor apparatus, at least one inter-dependent task from the at least one task group on a core of the multi-core processor apparatus.

### CROSS-REFERENCE TO RELATED APPLICATION

This application claims priority under 35 U.S.C. §119(a) to Indian Complete Patent Application Serial No. 201641025728 (CS) filed on Jul. 27, 2016 in the Indian Intellectual Property Office, the entire disclosure of which is incorporated herein by reference.

### BACKGROUND

### 1. Field

At least some example embodiments of the inventive concepts relate, generally, to a multi-core processor system and, more specifically, to an apparatus and method for group-based scheduling in a multi-core processor system.

### 2. Related Art

Multi-core devices include processors equipped with two or more processing cores that are capable of processing multiple tasks at the same time. Further, multi-core processors are typically more efficient than single-core processors in terms of performance and power consumption, and, as a result, multi-core processors have attracted an increasing amount of attention. Each processing core in a multi-core processing system executes tasks independently. Accordingly, some of the processing cores in the multi-core processor system can become idle. In an example, there can be cores that stop executing tasks and are on stand-by until other processing cores complete their tasks. The cores that are idle without executing tasks are referred to as idle cores. The presence of these idle cores can be associated with a waste of system resources.

Further, multi-core applications override traditional assumptions about the underlying multi-core processor system like exclusive execution, data protection by virtue of a task priority (for example, in single core systems, a high priority task can assume that a low priority task cannot access data simultaneously). Redesigning existing software for use with multi-core processor systems can be painstaking and expensive.

In conventional priority based scheduling, “N” highest priority ready tasks are scheduled on “N” cores of a multi-core processor system. This type of scheduling may be useful for a system in which the “N” tasks do not have any data dependency between them. Otherwise, a cost of synchronization between all the tasks may be very high. In other conventional same priority scheduling, tasks with the same priority may be active at any point of time. Further, efficient utilization can require moving multiple tasks to the same priority group. In other conventional static binding mechanisms, task binding is fixed to the core when it is created, thus resulting in core idling in scenarios where task load is specific. Consequently, core utilization may be reduced or, alternatively, minimal. The above descried conventional methods are static in nature and a relationship between the tasks may not be taken into consideration.

### SUMMARY

An aspect of at least some example embodiments of the inventive concepts is to provide an apparatus and a method for group-based scheduling in a multi-core processor system.

Another aspect of at least some example embodiments of the inventive concepts is to provide an apparatus and a method for determining, by a dynamic grouping unit, inter-dependent tasks from a plurality of tasks based on a plurality of parameters.

Another aspect of at least some example embodiments of the inventive concepts is to provide an apparatus and a method for generating, by the dynamic grouping unit, at least one task group including the inter-dependent tasks.

Another aspect of at least some example embodiments of the inventive concepts is to provide an apparatus and a method for scheduling, by a dynamic scheduling unit, at least one inter-dependent task from the at least one task group on a core of the multi-core processor system.

According to at least some example embodiments of the inventive concepts, a method for group-based scheduling in a multi-core processor apparatus comprises computing a cost of at least two tasks accessing a same resource based on a plurality of parameters; determining, by the multi-core processor apparatus, inter-dependent tasks from among a plurality of tasks based on a plurality of parameters by comparing the computed cost of the at least two tasks with a task inter-dependent threshold; generating, by the multi-core processor apparatus, at least one task group including the inter-dependent tasks; and scheduling, by the multi-core processor apparatus, at least one inter-dependent task from the at least one task group on a core of the multi-core processor apparatus.

According to at least some example embodiments of the inventive concepts, an apparatus includes a memory storing computer-readable instructions; and a multi-core processor configured to execute the computer-readable instructions such that the multi-core processor is configured to compute a cost of at least two tasks accessing a same resource based on a plurality of parameters, determine inter-dependent tasks from among a plurality of tasks by comparing the computed cost of the at least two tasks with a task inter-dependent threshold, generate at least one task group including the inter-dependent tasks, and schedule at least one inter-dependent task from the at least one task group on a core of the multi-core processor apparatus.

According to at least some example embodiments of the inventive concepts, a non-transitory computer-readable medium stores instructions that, when executed by a processor, cause the processor to perform operations including computing a cost of at least two tasks accessing a same resource based on a plurality of parameters; determining inter-dependent tasks from among a plurality of tasks by comparing the computed cost of the at least two tasks with a task inter-dependent threshold; generating at least one task group comprising the inter-dependent tasks; and scheduling at least one inter-dependent task from the at least one task group on a core of the multi-core processor apparatus.

According to at least some example embodiments of the inventive concepts, a method includes determining a cost, in central processor unit (CPU) cycles, of at least two tasks, from among a plurality of tasks of a multi-core processor apparatus, accessing a same resource; determining whether the at least two tasks are inter-dependent based on the cost and a threshold value; if the at least two tasks are determined to be inter-dependent, assigning the at least two inter-dependent tasks to a task group, the task group including a plurality of inter-dependent tasks from among the plurality of tasks of the multi-core processor apparatus; and scheduling at least one inter-dependent task, from among the plurality of inter-dependent tasks included in the task group, to be executed on a core of the multi-core processor apparatus.

### BRIEF DESCRIPTION OF FIGURES

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 illustrates various units of an apparatus for group-based scheduling in a multi-core processor system, according to at least some example embodiments of the inventive concepts;

FIG. 2 is a flow chart illustrating a method for group-based scheduling in a multi-core processor system, according to at least some example embodiments of the inventive concepts;

FIG. 3A illustrates an example in which tasks are accommodated in a single core system, according to at least some example embodiments of the inventive concepts;

FIG. 3B illustrates another example in which at least two tasks are grouped into a task group, according to at least some example embodiments of the inventive concepts;

FIG. 4A illustrates an example in which at least one inter-dependent task from a task group is scheduled on a core of a multi-core processor system, according to at least some example embodiments of the inventive concepts;

FIG. 4B illustrates another example in which at least one inter-dependent task from a task group is scheduled on a core of a multi-core processor system, according to at least some example embodiments of the inventive concepts;

FIG. 4C illustrates an example in which at least one inter-dependent task with same priority from a task group is scheduled on a core of a multi-core processor system, according to at least some example embodiments of the inventive concepts; and

FIG. 5 illustrates a computing environment implementing the apparatus and method for group-based scheduling in a multi-core processor system, according to at least some example embodiments of the inventive concepts.

### DETAILED DESCRIPTION

As is traditional in the field of the inventive concepts, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

At least some example embodiments of the inventive concepts are directed to a method for group-based scheduling in a multi-core processor system. According to at least some example embodiments of the inventive concepts, the method includes determining inter-dependent tasks from a plurality of tasks based on a plurality of parameters. Further, according to at least some example embodiments of the inventive concepts, the method includes generating at least one task group comprising the inter-dependent tasks. Further, according to at least some example embodiments of the inventive concepts, the method includes scheduling at least one inter-dependent task from the at least one task group on a core of the multi-core processor system.

The method, according to at least some example embodiments of the inventive concepts, may include determining the inter-task relationship based on parameters described below:
1. Quantity: How much of resource (code/data) is shared between tasks?
2. Frequency: How often do shared resources is accessed?
3. Timing: How often do tasks compete with each other?

The synchronization and communication between the tasks are highly dependent on an application scenarios under consideration (for example, in a modem system-on-chip (SoC), different application scenarios may include downlink (DL) only traffic, uplink (UL) only traffic, or Bi-directional traffic based on application scenario). Further, the communication may be expensive on the multi-core processor systems. The tasks which are active on any core may need a message exchange across the core.

According to at least some example embodiments of the inventive concepts, consider a scenario where the inter-dependent tasks having different priority are grouped in the task group. Grouping ensures serial execution of the tasks based on their priority. If an application scenario demands serialization of 2 inter-dependent tasks only for specific instances of time and not during complete execution of the inter-dependent tasks, grouping can be avoided (i.e., by-passed) with an option provided by a real-time operating system (RTOS) to enforce selective serialization. For example, the RTOS may provide an option for a “DEFER” mode API execution in their communication and synchronization APIs. If the “DEFER” mode is selected, the RTOS may ensure the following as described below:
A high priority task sending a message to (i.e., communicating with) a low/same priority task. The posting of the message may be deferred until the high priority task completes its execution and relinquishes the processor.
A low priority task sending a message to (i.e., communicating with) a high priority task. The message may be posted making the high priority task READY for execution. The low priority task may be held in forced suspension by the RTOS till the newly enabled task completes its execution and relinquishes the processor.
   Unlike at least some conventional systems and methods, the proposed method provides an option for selective serialization (i.e., serialization can be forced only for a certain set of messages exchange).

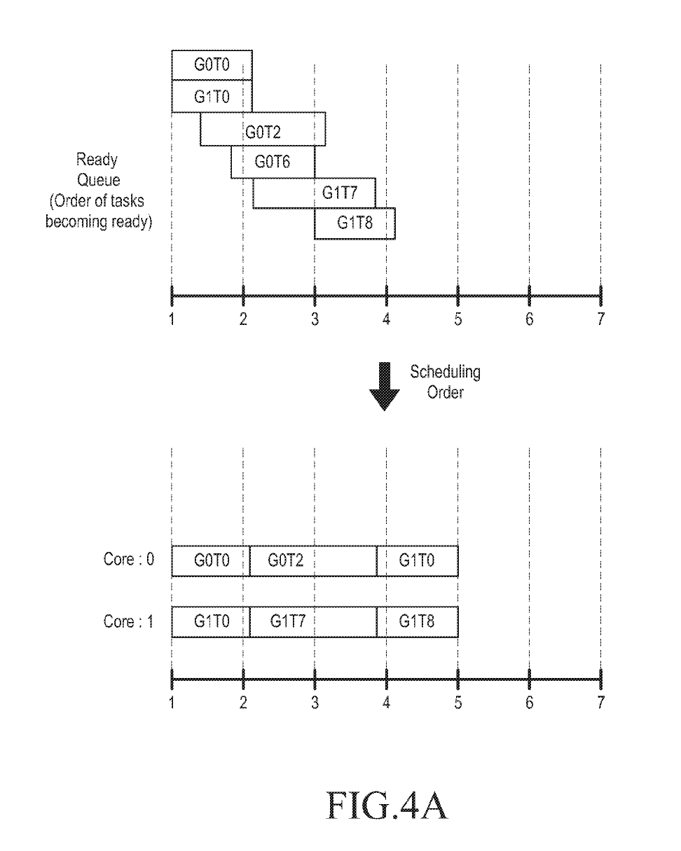

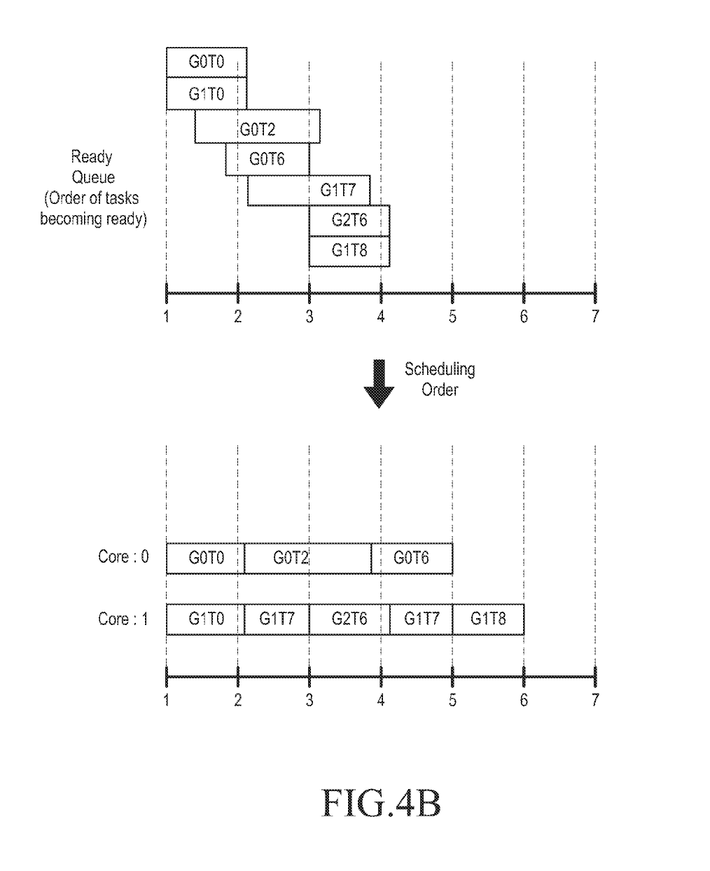

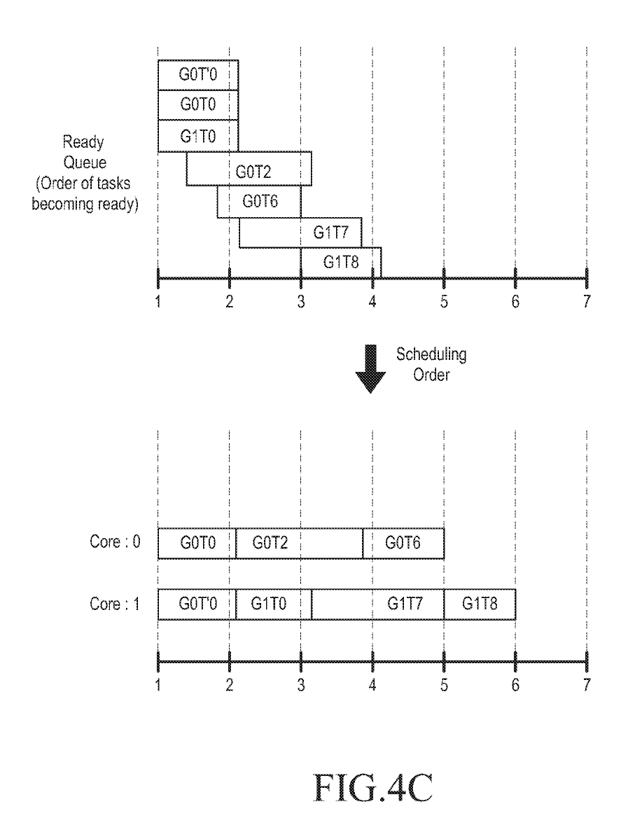

Unlike at least some conventional systems and methods, a more robust and simple method is provided for group-based scheduling in the multi-core processor system. Further, the method according to at least some example embodiments of the inventive concepts can be used to identify grouping amongst the given set of tasks in the multi-core processor system during runtime, and may keep re-organizing them into dynamic groups. The grouping can be either static or dynamic. Unlike at least some conventional systems and methods, grouped tasks may be scheduled in a more efficient way, which may help to increase processor utilization and reduce un-necessary synchronization overhead. By the method according to at least some example embodiments, multiple inter-dependent tasks having the same priority from the same task group can be scheduled at the same time, where each inter-dependent task is scheduled on a single core of the multi-core processor system. At least two tasks of a same priority belonging to a same group can be scheduled on at least two different cores at the same time (FIG. 4c)—provided they are at least two highest priorities READY tasks in the system.

Unlike at least some conventional systems and methods, the inter-dependent tasks having a highest priority from the task group are active and are scheduled on the cores of the multi-core processor system. According to at least some example embodiments of the inventive concepts, each inter-dependent task is scheduled on a single core of the multi-core processor system.

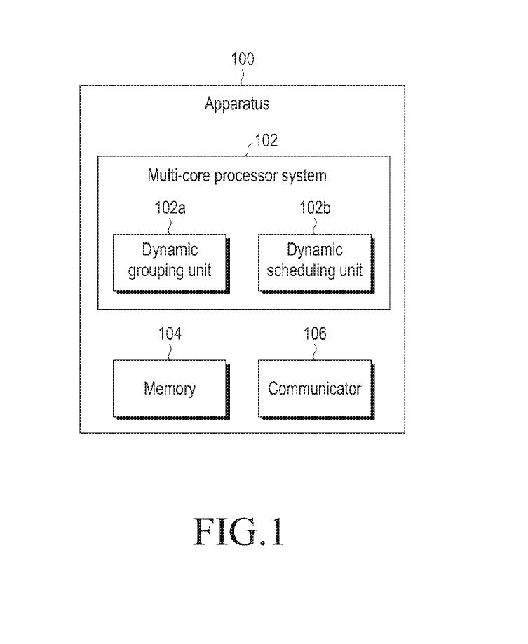

Referring now to the drawings, and more particularly to FIGS. 1 through 5, similar reference characters denote corresponding features consistently throughout the figures.

FIG. 1 illustrates various units of an apparatus 100 for group-based scheduling in a multi-processor system 102, according to at least some example embodiments of the inventive concepts. According to at least some example embodiments of the inventive concepts, the apparatus 100 includes the multi-core processor system 102, a memory 104, and a communicator 106. According to at least some example embodiments, the multi-core processor system 102 is a multi-core processor (e.g., a central processing unit (CPU) with multiple processing cores) that includes a dynamic grouping unit 102a and a dynamic scheduling unit 102b. The multi-core processor system 102 may also be referred to, herein, as the CPU 102. The apparatus 100 can be, for example, a laptop, a desktop computer, a mobile phone, a smart phone, Personal Digital Assistants (PDAs), a tablet, a phablet, or any other electronic device.

The dynamic grouping unit 102a can be configured to compute a cost of at least two tasks accessing the same resource based on a plurality of parameters. Examples of the above-referenced plurality of parameters include a frequency of accessing data within a resource by the at least two tasks belonging to a different task group, a time duration of accessing data within the resource by the at least two tasks belonging to the different task group, and a number of CPU cycles required for accessing data within the resource by the at least two tasks belonging to the different task group. Further, the dynamic grouping unit 102a can be configured to detect that the cost of the at least two tasks accessing the same resource meets a task inter-dependent threshold. The threshold may be a configurable parameter, and may be received as an input from a configuration file. According to at least some example embodiments of the inventive concepts, the task inter-dependent threshold is dynamically defined based on available central processing unit (CPU) idle. Further, the dynamic grouping unit 102a can be configured to declare the at least two tasks as inter-dependent tasks.

Further, the dynamic grouping unit 102a can be configured to generate task group(s) including the inter-dependent tasks. According to at least some example embodiments of the inventive concepts, the inter-dependent tasks are determined and grouped dynamically during run-time. According to at least some example embodiments of the inventive concepts, the dynamic grouping unit 102a can be configured to generate the at least one task group including the inter-dependent tasks having different priorities. Further, the dynamic scheduling unit 102b can be configured to determine at least one inter-dependent task from the task group that is in a ready state. Further, the dynamic scheduling unit 102b can be configured to determine a priority associated with the at least one inter-dependent task in the ready state. Further, the dynamic scheduling unit 102b can be configured to schedule the at least one inter-dependent task in the ready state on the core of the multi-core processor system 102 based on the priority.

According to at least some example embodiments of the inventive concepts, the inter-dependent task having a highest priority from the task group is active at a time unit on the core of the multi-core processor system 102. According to at least one other example embodiment of the inventive concepts, the inter-dependent tasks having a same priority from the task group are active at the time unit on the core of the multi-core processor system 102. According to at least some example embodiments of the inventive concepts, consider a scenario where there is “N” task groups on “M” core system, where “N” can be greater than “M”.

The memory 104 may include one or more computer-readable storage media. The memory 104 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 104 may, in some examples, be considered a non-transitory storage medium. The term “non-transitory” may indicate that the storage medium is not embodied in a carrier wave or a propagated signal. However, the term “non-transitory” should not be interpreted to mean that the memory 104 is non-movable. In certain examples, a non-transitory storage medium may store data that can, over time, change (e.g., in Random Access Memory (RAM) or cache). The communicator 106 can be configured for communicating internally between the units and externally with the networks. According to at least some example embodiments of the inventive concepts, the communicator 106 may include circuitry for communicating internally between the units and externally with the networks including, for example, one or more data buses connected between units of the apparatus 100, and one or more data input/output (I/O) circuits configured to receive and/or output data with respect to the apparatus 100.

The FIG. 1 shows example units of the apparatus 100. However, at least some example embodiments of the inventive concepts are not limited to the units illustrated in FIG. 1. According to at least some other example embodiments of the inventive concepts, the apparatus 100 may include a number of units that is greater or lower than the number of units illustrated in FIG. 1 with respect to the apparatus 100. Further, the labels or names of the units are used for illustrative purposes, and at least some example embodiments of the inventive concepts are not limited to the labels or names of units illustrated in FIG. 1. For example, according to at least some example embodiments of the inventive concepts, two or more units of the apparatus 100 illustrated in FIG. 1 may be combined into a single unit that performs any or all of the functions of the two or more units. According to at least some example embodiments, one or both of the dynamic grouping unit 102a and the dynamic scheduling unit 102b may be implemented (e.g., embodied) by the multi-core processor system 102 executing program code that is stored in memory (e.g., the memory 104) and includes instructions for causing the multi-core processor system 102 to perform the operations described herein as being performed by the dynamic grouping unit 102a and the dynamic scheduling unit 102b.

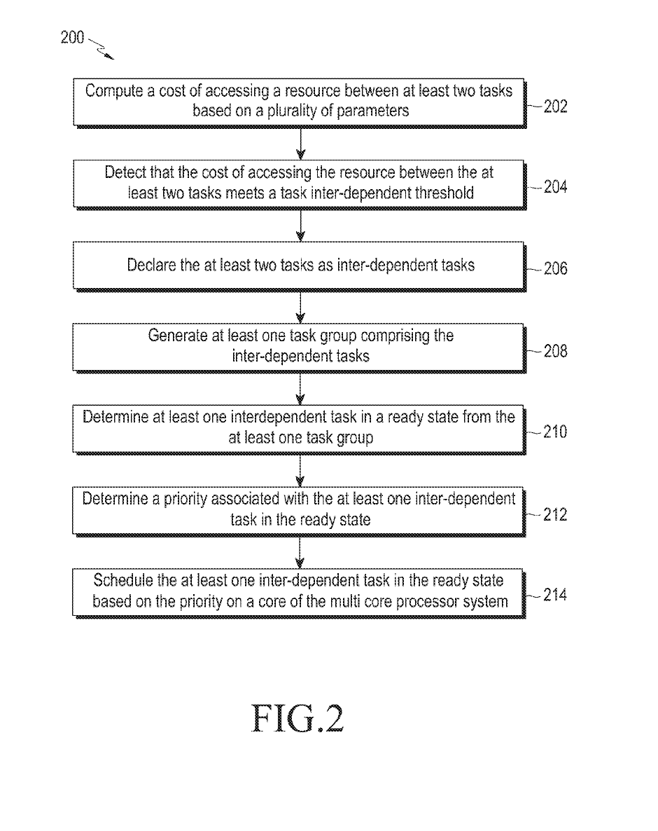

FIG. 2 is a flow chart 200 illustrating a method for group-based scheduling in the multi-core processor system 102, according to at least some example embodiments of the inventive concepts. According to at least some example embodiments, any or all of the operations illustrated in FIG. 2 and/or described below with respect to FIG. 2 may be performed by the multi-core processor system 102 executing program code that is stored in memory (e.g., the memory 104) and includes instructions for causing the multi-core processor system 102 to perform the operations illustrated in FIG. 2 and/or described below with respect to FIG. 2. At step 202, the method includes computing the cost of the at least two tasks accessing the same resource based on the plurality of parameters. The method allows the dynamic grouping unit 102a to compute the cost of the at least two tasks accessing the same resource based on the plurality of parameters.

At step 204, the method includes detecting that the cost of the at least two tasks accessing the same resource meets the task inter-dependent threshold. For example, in step 204, the dynamic grouping unit 102a may detect that the cost of the at least two tasks accessing the same resource meets or exceeds (i.e., is greater than or equal to) the task inter-dependent threshold. According to at least some example embodiments of the inventive concepts, the task inter-dependent threshold is dynamically defined based on the available CPU idle. In the step 204, the detection can be performed if the at least two tasks under consideration for grouping meets the required criteria (for example, the task inter-dependent threshold). Tasks which don't meet the required criteria aren't grouped together (not depicted).

According to at least some example embodiments of the inventive concepts, the task inter-dependent threshold is a dynamic parameter in the multi-core processor system 102, which the multi-core processor system 102 may set such that the task inter-dependent threshold is directly proportional to the available CPU idle (historical). With regard to the term “historical”, an instantaneous CPU IDLE time on each core may be not considered for deciding inter-dependent threshold. Average CPU IDLE derived over a period of time may be considered. (Average time window is configurable parameter, some systems needs averaging over lesser duration—and some systems need averaging over longer duration) and in case CPU idle is high, the task inter-dependent threshold is increased and vice versa. For example, the task inter-dependent threshold may be set by the CPU 102 based on a percentage of time the CPU 102 spends idle, for example, with respect to a sliding window of time. If the CPU 102 is idling, the method according to at least some example embodiments allows inter-dependent tasks to co-exist in different task groups and utilize active cores, even if the inter-dependent tasks exhibit high communication frequency and/or have substantial data synchronization requirements. Further, some of the cores can be turned-off due to an RTOS power saving scheme.

Further, the RTOS may provide a common application program interface (API) for synchronization, which is internally taken care of synchronization (explicit or zero cost) across inter or intra core (or group). Consequently, according to at least some example embodiments of the inventive concepts, users can be agnostic with respect to the dynamic grouping, and requiring explicit intra-core or inter-core synchronization while sharing or accessing the common data structures and internal data elements of the data structures.

At step 206, the method includes declaring the at least two tasks as the inter-dependent tasks. For example, according to at least some example embodiments, in response to determining, in step 204, that the cost of the at least two tasks accessing the same resource meets or exceeds the task inter-dependent threshold, the dynamic grouping unit 102a may declare the at least two tasks as the inter-dependent tasks. For example, the dynamic grouping unit 102a may designate the at least two tasks as inter-dependent tasks and store information, for example in the memory 104, identifying the at least two tasks as being inter-dependent tasks. At step 208, the method includes generating the task group including the inter-dependent tasks. For example, at step 208, the dynamic grouping unit 102a may generate the task group including the inter-dependent tasks. According to at least some example embodiments of the inventive concepts, the inter-dependent tasks are determined and grouped dynamically during run-time.

### Grouping Scheme:

Unlike at least some conventional systems and methods, the hardware unit (i.e., dynamic grouping unit 102a) is proposed which identifies grouping amongst the plurality of tasks in the multi-core processor system 102 during the run-time, and keeps re-organizing the tasks into the task groups. The dynamic grouping unit (DGU) 102a and dynamic scheduling unit (DSU) 102b can be either implemented in software or as the hardware unit. The need for the hardware unit might arise if the processing carried out by the DGU and the DSU turns complex. In addition, the hardware unit in such cases can be as simple as a co-processor associated with a symmetric multiprocessing (SMP) system. The dynamic grouping unit 102a may assign at least two tasks to the task group if there is inter-dependence between the tasks, which are identified based on, for example, one or more of the plurality of parameters (e.g., a frequency of accessing data within a resource by the at least two tasks belonging to a different task group, a time duration of accessing data within the resource by the at least two tasks belonging to the different task group, and/or a number of CPU cycles required for accessing data within the resource by the at least two tasks belonging to the different task group). In some cases, a particular task (i.e., parent) can fork (spawn) new children tasks (at the same or different priority) to handle independent or simultaneous events or messages.

According to at least some example embodiments of the inventive concepts, an event, message, signal, or other inter-task communication entity is shared from one task to the other, which leads to accessing of one or more data units in one or more data structures that are common to both the tasks. According to at least some example embodiments of the inventive concepts, the tasks may be grouped dynamically as described below.

According to at least some example embodiments of the inventive concepts, the designation of at least two tasks ad inter-dependent tasks, and the grouping of the inter-dependent tasks are carried out after considering costs of communication and synchronization (i.e., cost in terms of CPU cycles) between the at least two tasks if the at least two tasks are to be grouped separately. Further, the cost of synchronization is reduced or, alternatively, minimal if the at least two tasks are placed in the same task group, in which case a cost of synchronization can be handled locally without the need for explicit synchronization mechanisms.

Further, there is the known cost of communication between the inter-dependent tasks, which is constant Cost_{comm} and frequency of communication is “k”, then the cost of communication between a pair of tasks is given by k*Cost_{comm}. Further, there is a known cost of accessing a particular data in the data structure in terms of avoidance of race conditions in accessing the data structure through software or hardware mechanism. If the cost of all such communication and all access to the data within the data structures shared between the tasks is higher than the task inter-dependent threshold, then the at least two tasks are considered as inter-dependent.

### Cost Calculation:

The process for computing the cost of the at least two tasks accessing the same resource based on the plurality of parameters is described below.

Let, Cᵢⱼ=Cost of accessing a data unit i within data structure j (i.e., datastructureⱼ) when the at least two tasks do not belong to the same task group.

Cⱼ=Cost of accessing the datastructureⱼ when the at least two tasks do not belong to the same task group=Σᵢ₌₀ⁱ⁼ⁿFᵢⱼ*Cᵢⱼ*Tᵢⱼ, where n is a maximum number of data units, and Fᵢⱼ denotes the frequency with which data unit i of data structure j is accessed or shared between the at least two tasks that do not belong to the same task group, and Tᵢⱼ denotes the duration of access for the respective data.

Further, the cost of communication is due to inter-process communication (IPC) spanning across cores of the multi-core processor system 102 when the at least two tasks do not belong to the same group. Thus, it is assumed that the Cost_{comm}=0 when the at least two tasks belong to the same group (as intra core IPC cost is assumed to be ‘0’). Further, the cost of synchronization is due to locks spanning across cores when the at least two tasks do not belong to the same group. Thus, it is assumed that Cost=0 when the at least two tasks belong to the same group (as intra core cost of lock is assumed to be ‘0’). In some cases, the cost of synchronization of at least two tasks belonging to different groups accessing one unit of data in a data structure is the same as the cost of accessing multiple data units in the data structure. Different members of the data structure and even different set of data structures can be protected by using same synchronization entities. Therefore, synchronization locks required and cost of synchronization for accessing one member of the data structure or different members remains same. However, in such cases, the total cost may be directly proportional to amount of time it takes to access the data i.e., logically the cost of locking once and accessing one or all of such shared data.

Further, the cost of communication across the cores, and cost of locking (for synchronization) is known a priori to the operating system (and is measured for each processor and stored as a look up table within the scope of the operating system). The cost of at least two tasks to belong to different task groups is given below:

In an example, the cost of keeping Taskₚ and Task_{q} in different task groups Gₖ and Gₗ respectively=Σⱼ₌₁^{j=m}+(k*Cost_{comm}), where m is the total number of shared data-structures between the two tasks belonging to different task groups.

At step 210, the method includes determining the at least one inter-dependent task in the ready state from the task group. According to at least some example embodiments of the inventive concepts, at step 210, the dynamic scheduling unit 102b determines the at least one inter-dependent task in the ready state from the task group. At step 212, the method includes determining the priority associated with the at least one inter-dependent task in the ready state. According to at least some example embodiments of the inventive concepts, at step 212, the dynamic scheduling unit 102b determines the priority associated with the at least one inter-dependent task in the ready state.

At step 214, the method includes scheduling the at least one inter-dependent task in the ready state based on the priority on at least one core of the multi-core processor system 102. According to at least some example embodiments of the inventive concepts, at step 214, the dynamic scheduling unit 102b schedules, based on the priority determined in step 212, the at least one inter-dependent task that is in the ready state on the at least one core of the multi-core processor system 102. According to at least some example embodiments of the inventive concepts, “N” highest ready tasks are scheduled on N cores adhering to the criteria below.
1. Only tasks belonging to one priority from the task group can be active at any point of time.
2. Two or more tasks from the same task group are optionally allowed to execute, if the tasks belong to the same priority. In this way, if the two tasks of the task group are competing and linear in their activities, the two tasks can be scheduled on individual cores.

According to at least some example embodiments of the inventive concepts, the techniques used for grouping the inter-dependent tasks into the task group are described below:

Technique-1:
1. Initiate: All tasks belong to the same task group—G₁.
2. Continuously achieve: Each task group Gᵢ has at least one task.
3. The operating system continuously tracks and updates:∀Taskₚ, Task_{q}, m data-structures shared between them, and for each such data-structure n data within the data structures are shared (include the frequency of each of them). This can either be analyzed based on number of synchronization API invoked in logic code, or through a historical analysis of unique tasks waiting on a synchronization object and can also be tracked by the operating system, for example through memory access utility. Thus every data accessed by the task is marked (say a count is maintained), and for each access of the same data by another task, the data is marked again (counter is incremented).

∀Taskₚ, Task_{q}, the total cost for keeping the tasks in different groups Gₖ and Gₗ respectively is calculated as Σⱼ₌₁^{j=m}Cⱼ+(Cost_{comm}). The equation Σⱼ₌₁^{j=m}Cⱼ+(Cost_{comm}) refer to the process of calculating Cost as indicated in earlier steps of FIG. 2.

If Σⱼ₌₁^{j=m}Cⱼ≦=Threshold, then Taskₚ is assigned to the task group Gₖ and Task_{q} is assigned to the task group Gₗ.

If Σⱼ₌₁^{j=m}Cⱼ>Threshold, then Task and Task_{q} are assigned to same task group Gₖ.

Technique-2:
1. Starting Point, the task group Gᵢ each has only 1 task, where total number of task groups is the same as the number of tasks.
2. Continuously achieve: Each Group Gi has at least 1 Task.
3. Operating system continuously tracks and updates, which is same as Technique-1.

Technique-3:
1. Starting Point, the task group Gᵢ has one or more tasks, which were initially grouped based on analysis and explicitly placing certain tasks in associated groups (RTOS provides the API for this purpose).
2. Continuously achieve: Each task group Gₖ has at least one task (k is not be equal to j).
3. Operating system continuously tracks and updates, which is same as described in Technique-1.

The various actions, acts, blocks, steps, or the like in the method may be performed in the order presented, in a different order or simultaneously. According to at last some example embodiments of the inventive concepts, some of the actions, acts, blocks, steps, or the like of the method may be omitted, added, modified, skipped, or otherwise altered.

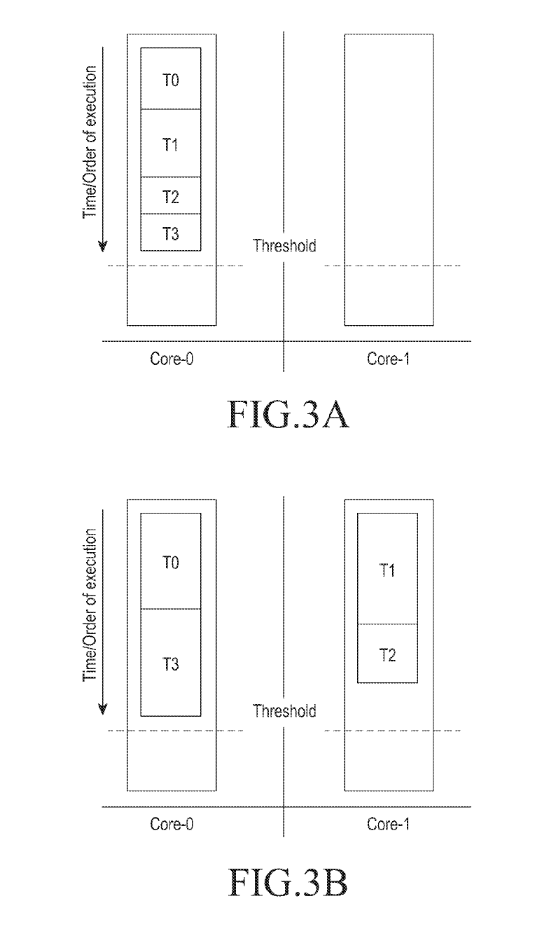

FIG. 3A illustrates an example in which tasks are accommodated in a single core system, according to at least some example embodiments of the inventive concepts. As shown in the FIG. 3A, T0, T1, T2, and T3 are the tasks and the priority of the tasks is shown below:
T0>T1>T2>T3

Further, core-1 is left idle to save power when all the tasks can be accommodated in the single core system.

FIG. 3B illustrates another example in which the at least two tasks are grouped into the task group, according to at least some example embodiments of the inventive concepts. Consider a scenario in which decision to use two cores is made. Further, the dynamic grouping technique is triggered and grouping is decided based on the cost calculation as described above. The cost of synchronization between the tasks (T0 and T3) and the tasks (T1 and T2) pair is less.

FIG. 4A illustrates an example in which the at least one inter-dependent task from the task group is scheduled on the at least one core of the multi-core processor system 102, according to at least some example embodiments of the inventive concepts. As shown in the FIG. 4A, “G0T0” represents the task from the task group-0 with the priority “0”, “G0T2” represents the task from the task group-0 with the priority “2”, and “G0T6” represents the task from the task group-0 with the priority “6”.

Further, “G1T0” represents the task from the task group-1 with the priority “0”, “G1T7” represents the task from the task group-1 with the priority “7”, and “G1T8” represents the task from the task group-1 with the priority “8”. The grouping of the inter-dependent tasks is performed based on the cost factor between the tasks.

As shown in the FIG. 4A, all the tasks are ready at time unit 1. The higher priority task from the task group-1 (i.e., T10) is scheduled on the core-1. Similarly, the higher priority task from the task group-0 (i.e., T00) is scheduled on core-O.

FIG. 4B illustrates another example in which the at least one inter-dependent task from the task group is scheduled on the at least one core of the multi-core processor system 102, according to at least some example embodiments of the inventive concepts. Consider a scenario where the task from a task group-2 is being activated (i.e., G2T6) when the task group-0 and the task group-1 are active. As shown in the FIG. 4B, the task “G1T7” is preempted since the highest priority task from the task group-2 has become ready which is not executed.

FIG. 4C illustrates an example in which the at least one inter-dependent task with the same priority from the task group is scheduled on the at least one core of the multi-core processor system 102, according to at least some example embodiments of the inventive concepts. As shown in the FIG. 4C, “GOT′0” and “G0T0” represents the two tasks from the same task group with the same priority.

Consider a scenario in which multiple tasks with the same priority from the task group-0 are active (i.e., task priority is higher than other ready task of other group. In this case, it is assumed that the same priority tasks do not assume implicit synchronization support. As the tasks “G0T0” and “G0T0” from the task group-0 have the same priority, the task “G0T0” is scheduled on the core-0 and at the same time the task “G0T0” is scheduled on the core-1.

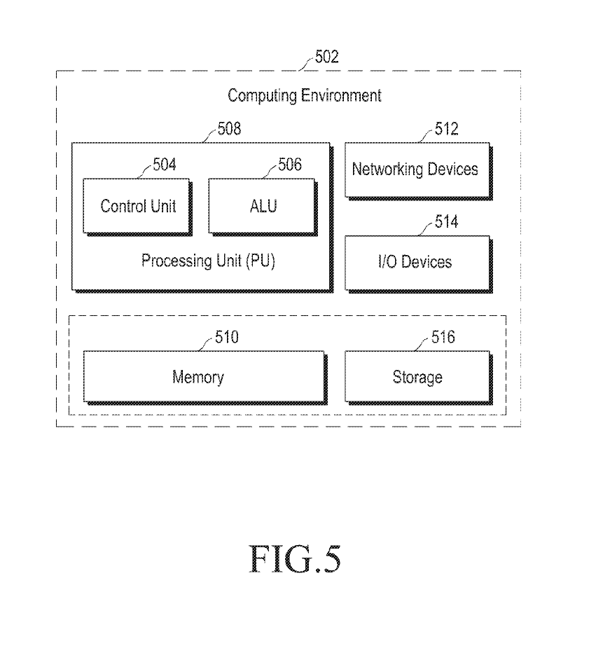

FIG. 5 illustrates a computing environment implementing the method and system for group-based scheduling in the multi-core processor system 102, according to at least some example embodiments of the inventive concepts. As depicted in the figure, the computing environment 502 comprises at least one processing unit 508 that is equipped with a control unit 504 and an Arithmetic Logic Unit (ALU) 506, a memory 510, a storage unit 512, plurality of networking devices 516 and a plurality Input output (I/O) devices 514. The processing unit 508 is responsible for processing the instructions of the schemes. The processing unit 508 receives commands from the control unit 504 in order to perform its processing. Further, any logical and arithmetic operations involved in the execution of the instructions are computed with the help of the ALU 506.

The overall computing environment 502 can be composed of multiple homogeneous or heterogeneous cores, multiple CPUs of different kinds, special media and other accelerators. The processing unit 508 is responsible for processing the instructions of the schemes (i.e. the Technique-1 to Technique-3). Further, a plurality of processing units having the structure of the processing unit 508 may be located on a single chip or over multiple chips.

The scheme comprising of instructions and codes required for the implementation are stored in either the memory unit 510 or the storage 512 or both. At the time of execution, the instructions may be fetched from the corresponding memory 510 or storage 512, and executed by the processing unit 508.

In case of any hardware implementations various networking devices 516 or external I/O devices 514 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 5 include blocks which can be at least one of a hardware device, or a combination of hardware device and software units.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A method for group-based scheduling in a multi-core processor apparatus, the method comprising:
computing a cost of at least two tasks accessing a same resource based on a plurality of parameters;
determining, by the multi-core processor apparatus, inter-dependent tasks from among a plurality of tasks by comparing the computed cost of the at least two tasks with a task inter-dependent threshold;
generating, by the multi-core processor apparatus, at least one task group including the inter-dependent tasks; and
scheduling, by multi-core processor apparatus, at least one inter-dependent task from the at least one task group on a core of the multi-core processor apparatus.

2. The method of claim 1, wherein the determining inter-dependent tasks comprises:
detecting that the cost of the at least two tasks accessing the same resource is equal to or greater than the task inter-dependent threshold; and
designating the at least two tasks as the inter-dependent tasks.

3. The method of claim 1, further comprising:
determining and grouping the inter-dependent tasks dynamically during run-time.

4. The method of claim 1, wherein the plurality of parameters includes at least one of a frequency of accessing data within a resource by at least two tasks belonging to different task groups, a time duration of accessing data within the resource by the at least two tasks, and a number of central processing unit (CPU) cycles required for accessing data within the resource by the at least two tasks.

5. The method of claim 4, further comprising:
dynamically defining, by the multi-core processor apparatus, the task inter-dependent threshold based on a percentage of time the multi-core processor apparatus spends idle.

6. The method of claim 1, wherein the scheduling comprises:
determining the at least one inter-dependent task is in a ready state from the at least one task group;
determining a priority associated with the at least one inter-dependent task; and
scheduling the at least one inter-dependent task on the core of the multi-core processor apparatus, based on the determined priority.

7. The method of claim 6, wherein an inter-dependent task having a highest priority from the at least one task group is active at a time unit on the core of the multi-core processor apparatus.

8. The method of claim 6, wherein inter-dependent tasks having a same priority from the at least one task group are active at a time unit on the core of the multi-core processor apparatus.

9. The method of claim 1, wherein the inter-dependent tasks have different priorities.

10. An apparatus comprising:
a memory storing computer-readable instructions; and
a multi-core processor configured to execute the computer-readable instructions such that the multi-core processor is configured to,
compute a cost of at least two tasks accessing a same resource based on a plurality of parameters,
determine inter-dependent tasks from among a plurality of tasks based on a plurality of parameters by comparing the computed cost of the at least two tasks with a task inter-dependent threshold,
generate at least one task group including the inter-dependent tasks, and
schedule at least one inter-dependent task from the at least one task group on a core of the multi-core processor apparatus.

11. The apparatus of claim 10, wherein the multi-core processor is configured to execute the computer-readable instructions such that the multi-core processor is configured to perform the determining of the inter-dependent by:
detecting that the cost of the at least two tasks accessing the same resource is equal to or greater than the task inter-dependent threshold; and
designating the at least two tasks as the inter-dependent tasks.

12. The apparatus of claim 10, wherein the multi-core processor is configured to execute the computer-readable instructions such that the multi-core processor is configured to determine and group the inter-dependent tasks dynamically during run-time.

13. The apparatus of claim 10, wherein the multi-core processor is configured to execute the computer-readable instructions such that the multi-core processor is configured such that the parameter is a frequency of accessing data within a resource by at least two tasks belonging to different task groups, a time duration of accessing data within the resource by the at least two tasks, and a number of central processing unit (CPU) cycles required for accessing data within the resource by the at least two tasks.

14. The apparatus of claim 13, wherein the multi-core processor is configured to execute the computer-readable instructions such that the multi-core processor is configured to define the task inter-dependent threshold dynamically, based on a percentage of time the multi-core processor apparatus spends idle.

15. The apparatus of claim 10, wherein the multi-core processor is configured to execute the computer-readable instructions such that the multi-core processor is configured to perform the scheduling by:
determining a priority associated with the at least one inter-dependent task, and
scheduling the at least one inter-dependent task on the core of the multi-core processor apparatus, based on the determined priority.

16. The apparatus of claim 10, wherein the multi-core processor is configured to execute the computer-readable instructions such that the multi-core processor is configured such that the inter-dependent tasks have different priorities.

17. A method comprising:
determining a cost, in central processor unit (CPU) cycles, of at least two tasks, from among a plurality of tasks of a multi-core processor apparatus, accessing a same resource;
determining whether the at least two tasks are inter-dependent based on the cost and a threshold value;
if the at least two tasks are determined to be inter-dependent,
assigning the at least two inter-dependent tasks to a task group, the task group including a plurality of inter-dependent tasks from among the plurality of tasks of the multi-core processor apparatus; and
scheduling at least one inter-dependent task, from among the plurality of inter-dependent tasks included in the task group, to be executed on a core of the multi-core processor apparatus.

18. The method of claim 17, wherein the determining a cost comprises:
computing the cost of the at least two tasks accessing the same resource based on a plurality of parameters.

19. The method of claim 18, wherein,
the at least two tasks belong to different task groups, and
the plurality of parameters includes at least one of a frequency of accessing data within a resource by the least two tasks, a time duration of accessing data within the resource by the at least two tasks, and a number of CPU cycles required for accessing data within the resource by the at least two tasks.

20. The method of claim 19, further comprising:
dynamically defining, by the multi-core processor apparatus, the threshold value based on a percentage of time the multi-core processor apparatus spends idle.
